(19) United States
(12) Patent Application Publication
(10) Pub. No.: US 2022/0314577 A1
(43) Pub. Date: Oct. 6, 2022

(54) UNDERLAYMENT

(71) Applicant: ECONCORE N.V., Leuven (BE)

(72) Inventors: Joris VAN DER EEM, ARNHEM (NL); Soon Joo BOVENSCHEN, Arnhem (NL); Ruud GRIES, Silvolde (NL)

(73) Assignee: ECONCORE N.V., Leuven (BE)

(21) Appl. No.: 17/631,740

(22) PCT Filed: Jul. 28, 2020
(86) PCT No.: PCT/EP2020/071294

§ 371 Date: Jan. 31, 2022

(30) Foreign Application Priority Data
Jul. 30, 2019 (EP) 19189072.2
Dec. 4, 2019 (EP) 19213574.7

(51) Int. Cl. B32B 5/22; B32B 3/12; B32B 27/12

(52) U.S. Cl. CPC B32B 5/22; B32B 3/12; B32B 27/12; B32B 2307/102; B32B 2419/00; B32B 2307/718; B32B 2307/732; B32B 2250/03; B32B 2250/02

(57) ABSTRACT

A composite comprising a core, a first cover layer and a second cover layer, wherein the core is provided from an uncut flat body, wherein the core is a three dimensional structure having a first main surface and a second main surface, the first cover layer is in contact with the first main surface creating multiple contact areas and the second cover layer is in contact with the second main surface creating multiple contact areas, wherein the multiple contact areas between the first cover layer and the first main surface are offset in x-direction and y-direction to the multiple contact areas between the second cover layer and the second main surface, characterized in that the first cover layer and the second cover layer are different.

The invention pertains to a composite and a method of producing such a composite in particular for the use as a floor underlayment, and to a flooring system comprising such a composite.

Impact sounds occur in multistoried apartments or buildings in the room directly below by for example a walking human, or an object falling on the floor or electrical devices such as a dish washer or a washer.

The impact sound can reach moderate to high noises, thus, the impact sound is highly disturbing for people in the room directly below the impact sound source.

In the past, a lot of effort was made for impact sound insulation. In general, there are two main solutions proposed which lead until now to reduce the impact sound.

The first solution is to increase the load on a floor slab by increasing the weight of a layer of floating screed and the second solution is to introduce an insulation layer between the floor slab and the layer of floating screed. This insulation layer decouples the layer of floating screed and the floor slab so that the impact sound cannot be transmitted directly and the transmission of impact sound is reduced.

Due to an increase of the migration from the land into urban places, the number of people living in a certain area also increases. Thus, there is still a demand for improving impact sound insulation and noise reduction in houses and in particular in high quality multistoried apartments or buildings.

DE 199 01 086 A1 discloses a sound absorbing system for ceilings in buildings, especially for wooden ceilings. The sound absorbing system comprises a floor slab, an insulating layer comprising void volumes, on the floor slab, and a structure comprising two sandwich floating screed plates and a core, wherein the core comprises low density material, and a wooden cover plate on the insulating layer. The low density material of the core provides high void volumes and these void volumes are connected to the void volumes of the insulating layer.

U.S. Pat. No. 4,860,506 discloses a floor panel for floating floor comprising floor panels elastically supported by buffer members laid on a floor framing and the panels are provided with a plurality of through holes and supporting means integrally united to the underside of the panels at proper intervals. Therefore, the void volumes of the floor panel are connected to each other to prevent compression and expansion of the air.

DE 10 2009 009 088 A1 discloses a sound absorbing system for building ceilings, in particular for wooden ceilings. The sound absorbing system comprises a layer of floating screed and a sound absorbing area, which is between the floor slab and the floating screed. The absorbing area comprises at least one airflow channel with a fluid resistance of at most 5 kPa·s·m⁻². This sound absorbing system is able to reduce the noise of impact sound at frequencies below 250 Hz by at most 15 dB.

U.S. Pat. No. 4,685,259 discloses a sound rated flooring comprising a composite panel structure including multiple layers. The composite panel comprises a core and at least one acoustically semi-transparent facing of fibrous material which is bonded to the core. The core can be a walled structure such as a honeycomb structure made of cardboard, kraft paper or aluminum. The cells of the honeycomb structure are open to a first side and to a second side.

US 2006/0230699 A1 discloses a sound control flooring system, which comprises a first layer and a second layer of sound absorbing material disposed on a subfloor assembly. The first layer can be a highly porous three dimensional matrix filamentous mat, a honeycomb structure made of cardboard, kraft paper or aluminum, as described in U.S. Pat. No. 4,685,259, or a plastic mat having projections. The second layer can be a plastic mat having a plurality of conical, dimple like, and/or cuspated projections extending therefrom.

EP 0 057 372 A1 discloses a hollow floor comprising a composite of a profiled material, a metal sheet and a thermal insulating layer.

The object of the present application is to provide a material which is able to reduce impact noises and is able to be used as underlayment for multiple floor coverings such as laminate, parquet, PVC flooring or floating screed and on multiple surfaces e.g. concrete or wooden floor slabs, tufted floor coverings, ceramic tiles, poured top floors.

The object is solved by a composite comprising a core, a first cover layer and a second cover layer, wherein the core is provided from an uncut flat body, wherein to the core is a three-dimensional structure having a first main surface and a second main surface, the first cover layer is in contact with the first main surface creating multiple contact areas and the second cover layer is in contact with the second main surface creating multiple contact areas, wherein the multiple contact areas between the first cover layer and the first main surface are offset in x-direction and/or y-direction to the multiple contact areas between the second cover layer and the second main surface, characterized in that the first cover layer and the second cover layer are different.

Without being bound to theory, it is believed that due to the different first cover layer and second cover layer the composite can be tailored to different undergrounds and floor coverings such that a sufficient stability and a good sound insulation, such as impact sound reduction, air born sound reduction, and sound reflection reduction, occurs. Thereby, stability means structural stability in z-direction (e.g. compression resistance) as well as stability in the plane of the x- and y-direction.

Within the scope of the invention, the uncut flat body has to be understood as a thin body, which is a one pieced body, i.e. which does not consist of multiple materials connected to each other. This means the uncut flat body consist of solely one body and is free of any connections, e.g. seams, glued portion or welded portions. Further, the term “provided from an uncut flat body” is understood to mean that the flat body is not cut to enable folding of the deformed sheet into a core having a three-dimensional structure. The substantially uncut flat body may however be cut to provide a certain width and/or length of the uncut flat body before the uncut flat body is plastically deformed. It is therefore to be understood that the core having a three-dimensional structure is formed from an uncut flat body.

Throughout this application, the term “plastically deformed” means a process where the uncut flat body is deformed by an external stretching force in such a way that it keeps its form also when the stretching force is released. The uncut flat to body may be plastically deformed only in local domains of its surface area. The plastically deformed uncut flat body may have the same dimensions in x-direction and in y-direction as the uncut flat body prior to plastic deformation. After being plastically deformed, the uncut flat body may have a three-dimensional structure. In an embodiment, the uncut flat body is stretched locally by the external force by at least 5% in machine direction, in cross machine direction or both. In an embodiment, the uncut flat body is stretched locally by the external force by at least 10% in machine direction, in cross machine direction or both. In an embodiment, the uncut flat body is stretched locally by the external force by at least 15% in machine direction, in cross machine direction or both. In an embodiment, the uncut flat body is stretched locally by the external force by at least 20% in machine direction, in cross machine direction or both. In an embodiment, the uncut flat body is stretched locally by the external force by at least 30% in machine direction, in cross machine direction or both. In an embodiment, the uncut flat body is stretched locally by the external force by at least 40% in machine direction, in cross machine direction or both. In an embodiment, the uncut flat body is stretched locally by the external force by at least 50% in machine direction, in cross machine direction or both. In an embodiment, the uncut flat body is stretched locally by the external force by at least 60% in machine direction, in cross machine direction or both. In an embodiment, the uncut flat body is stretched locally by the external force by at least 70% in machine direction, in cross machine direction or both. In an embodiment, the uncut flat body is stretched locally by the external force by at least 80% in machine direction, in cross machine direction or both.

The core provided from the uncut flat body is a three-dimensional structure which has a length (extension in x-direction, or also called machine direction), a width (extension in y-direction, also called cross machine direction or cross direction, both terms are used synonymously in the following), and a thickness (extension in z-direction). The x-direction and the y-direction define the plane of the core and are perpendicular to each other. The z-direction is extending out of the plane of the x- and y-direction perpendicularly.

The core has a first main surface, which is plane parallel to the plane of the x-direction and y-direction, and a second main surface, which is plane parallel to the first main surface at a distance defined by the thickness of the core.

In a preferred embodiment, the core is a folded uncut flat body or a deep drawn uncut flat body.

An example of a core, which is a folded uncut flat body is disclosed by WO 2006/053407 A1. This document discloses a folded honeycomb structure which is produced from an uncut continuous web of material by plastic deformation perpendicular to the plane of the material to thereby form half-hexagonal cell walls and small connecting areas. By folding the plastically deformed material in the direction of conveyance the half-hexagonal cell walls meet to form the honeycomb structure. In the following this honeycomb structure is called half-closed honeycomb structure.

Another example of a folded uncut flat body is disclosed by WO 2006/053407 A1, wherein the plastically deformed material is folded such that the cell walls may not be fully vertical. In the following this honeycomb structure is called a relaxed honeycomb structure. Relaxed honeycomb structures provide a greater flexibility than half-closed honeycomb structures. An underlayment material comprising a relaxed honeycomb structure may therefore be rollable.

Due to the fact, that the core is provided from an uncut flat body and the core has a three dimensional structure, parts of the uncut flat body extend in z-direction. Thereby, the z-extension of parts of the uncut flat body can be above the plane of x- and y-direction or below the plane of x- and y-direction. The main surfaces of the core are established solely by parts which are extending the most above the plane of the x- and y-direction or the most below the plane of the x- and y-direction. Thereby, the plane of x-direction and y-direction is located between the first main surface and the second main surface having equal distances between the first main surface and the plane and the second main surface and the plane.

In a preferred embodiment, the first main surface is established by parts of the uncut flat body, which are extending the most above the plane of the x- and y-direction, and the second main surface is established by parts of the uncut flat body, which are extending the most below the plane of the x- and y-direction.

In another preferred embodiment, the multiple contact areas between the first main surface and the first cover layer are established by the parts of the uncut flat body, which are extending the most above the plane in x-direction and y-direction and being in contact with the first cover layer, wherein the first cover may be plane parallel to the first main surface.

Preferably, the multiple contact areas between the second main surface and the second cover layer are established by the parts of the uncut flat body, which are extending the most below the plane in x-direction and y-direction and being in contact with the second cover layer, wherein the second cover may be plane parallel to the second main surface.

The multiple contact areas between the first main surface and the first cover layer are offset in x- and y-direction to the multiple contact areas between the second main surface and the second cover layer. Within the scope of the invention, offset in x- and y-direction means that the multiple contact areas between the first main surface and the first cover layer and the multiple contact areas between the second main surface and the second cover layer do not overlay in the plane of the x- and y-direction when considered in z-direction.

Thereby, the multiple contact areas have to be understood as the areas wherein the parts of the uncut flat body which are located in the first main surface, respectively which are located in the second main surface, solely extend in x-direction and y-direction.

In preferred embodiment, a first intermediate layer is located between the first cover layer and the first main surface of the core.

In a further preferred embodiment, a second intermediate layer is located between the second cover layer and the second main surface of the core.

Preferably, a first intermediate layer is located between the first cover layer and the first main surface and a second intermediate layer is located between the second cover layer and the second main surface.

Without being bound to theory, it is believed that the intermediate layer between the first cover layer and the first main surface and/or the second cover layer and the second main surface enables an increase in noise reduction as such a layer could reflect, deflect or disperse sound waves. Further, it is believed by having a first intermediate layer and a second intermediate layer the effect of noise reduction can be increased.

Preferably, the first intermediate layer is a continuous layer, a discontinuous layer, a film, a slit film, an adhesive, a hotmelt, a woven fabric, a nonwoven fabric, a continuous fiber web, a discontinuous fiber web, and/or a foam.

Preferably, the second intermediate layer is a continuous layer, a discontinuous layer, a film, a slit film, an adhesive, a hotmelt, a woven fabric, a nonwoven fabric, a continuous fiber web, a discontinuous fibber web, and/or a foam.

Preferably, the first intermediate layer and the second intermediate layer is a continuous layer, a discontinuous layer, a film, a slit film, an adhesive, a hotmelt, a woven fabric, a nonwoven fabric, a continuous fiber web, a discontinuous fibber web, and/or a foam.

In a preferred embodiment, the adhesive is an adhesive tape, an double sided adhesive tape, a pressure sensitive adhesive, and/or a reversible adhesive.

Without being bound to theory, it is believed that if the first intermediate layer and/or second intermediate layer is a continuous layer, a discontinuous layer, a film, a slit film, an adhesive, a hotmelt, a woven fabric, a nonwoven fabric, a foam, the first intermediate layer and/or the second intermediate layer improve the acoustic properties of the composite and/or increase the stability due to improved adhesion between the first cover layer and the core and/or between the second cover layer and the core.

In a preferred embodiment, the first intermediate layer comprises a synthetic polymeric material, a natural polymeric material, a mineral polymeric material, or a combination thereof.

In another preferred embodiment the second intermediate layer comprises a synthetic polymeric material, a natural material, a mineral material, or a combination thereof.

In a further preferred embodiment, the first intermediate layer and the second intermediate layer comprise a synthetic polymeric material, a natural polymeric material, a mineral polymeric material, or a combination thereof.

In a preferred embodiment, the first intermediate layer comprises a synthetic polymeric fiber material, a natural polymeric fiber material, a mineral polymeric fiber material, or a combination thereof.

In another preferred embodiment the second intermediate layer comprises a synthetic polymeric fiber material, a natural polymeric fiber material, a mineral polymeric fiber material, or a combination thereof.

In a further preferred embodiment, the first intermediate layer and the second intermediate layer comprise a synthetic polymeric fiber material, a natural polymeric fiber material, a mineral polymeric fiber material, or a combination thereof.

Within the scope of the present invention it is understood that the term fibers refers to both staple fibers and filaments. Staple fibers are fibers which have a specified, relatively short length in the range of 2 to 200 mm. Filaments are fibers having a length of more than 200 mm, preferably more than 500 mm, more preferably more than 1000 mm. Filaments may even be virtually endless, for example when formed by continuous extrusion and spinning of a filament through a spinning hole in a spinneret. Further, by using the term fibers also yarns comprising fibers or filaments are encompassed.

The fibers may have any cross sectional shape, including round, trilobal, multilobal or rectangular, the latter exhibiting a width and a height wherein the width may be considerably larger than the height, so that the fiber in this embodiment is a tape.

The advantage of a synthetic polymeric material is typically that the material is economical, can be manufactured in large amounts, has a constant quality and has advantageous physical properties such as elongation, elasticity and toughness. An advantage of natural polymeric material is that the material is renewable such that there is less environmental pollution by using such a material. An advantage of a mineral polymeric material is typically that the material has advantageous physical properties such as tensile strength, modulus, inflammableness and fire retardancy.

In a preferred embodiment of the invention, the first intermediate layer comprises a synthetic polymeric material, preferably a thermoplastic polymeric material.

In another preferred embodiment the second intermediate layer comprises a synthetic polymeric material, preferably a thermoplastic polymeric material.

Preferably, the first intermediate layer and the second intermediate layer comprises a synthetic polymeric material, preferably a thermoplastic polymeric material.

In a preferred embodiment of the invention, the synthetic polymeric material of the first intermediate layer is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

In a further preferred embodiment, the synthetic polymeric material of the second intermediate layer is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

Preferably, the synthetic polymeric material of the first intermediate layer and the second intermediate layer is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

In a preferred embodiment, the first intermediate layer has a weight of at most 1200 g/m², preferably of at most 300 g/m², more preferably of at most 200 g/m², even more preferably of at most 150 g/m², even more preferably of at most 100 g/m², and most preferably of at most 50 g/m².

In a further preferred, embodiment the second intermediate layer has a weight of at most 1200 g/m², preferably of at most 300 g/m², more preferably of at most 200 g/m², even more preferably of at most 150 g/m², even more preferably of at most 100 g/m², and most preferably of at most 50 g/m².

Preferably, the first intermediate layer and the second intermediate layer has a weight of at most 1200 g/m², preferably of at most 300 g/m², more preferably of at most 200 g/m², even more preferably of at most 150 g/m², even more preferably of at most 100 g/m², and most preferably of at most 50 g/m².

Without being bound to theory, it is believed that by increasing the weight of the first intermediate layer and/or the second intermediate layer of up to 200 g/m², the bonding strength between the first cover layer and the core and/or the second cover layer and the core is/are increased and/or the stability of the composite is improved. Further, it is believed that by exceeding 200 g/m² would deteriorate the acoustic properties of the composite. Also, it is believed that by decreasing the weight of the first intermediate layer or second intermediate layer to below 50 g/m², e.g. to less than 10 g/m² would deteriorate the stability of the composite. Further, due to the deterioration of the stability of the composite, the composite may be delaminate such that also the acoustic properties of the composite could be impacted. By increasing the weight of the first intermediate layer and/or the second intermediate layer to at least 300 g/m² the acoustic effect of noise reduction can be improved.

In a preferred embodiment of the invention, the first cover layer is a foam, a textile fabric, a sheet of material, a laminate of two or more layers, or any combination thereof.

In another preferred embodiment of the invention, the second cover layer is a foam, a textile fabric, a sheet of material, a laminate of two or more layers, or any combination thereof.

Preferably, the first cover layer and the second cover layer is a foam, a textile fabric, a sheet of material, a laminate of two or more layers, or any combination thereof.

Without being bound to theory, it is believed that a foam, a textile fabric, a sheet of material, or any combination thereof as the first cover layer and/or the second cover layer enables to increase the stability and/or the acoustic properties of the composite.

In a further preferred embodiment, the first cover layer has a weight of at most 1200 g/m², preferably of at most 500 g/m², more preferably of at most 250 g/m², even more preferably of at most 125 g/m², even more preferably of at most 60 g/m², and most preferably of at most 40 g/m².

In a further preferred embodiment, the second cover layer has a weight of at most 1200 g/m², preferably of at most 500 g/m², more preferably of at most 250 g/m², even more preferably of at most 125 g/m², even more preferably of at most 60 g/m², and most preferably of at most 40 g/m².

In a further preferred embodiment, the first cover layer as well as the second cover layer has a weight of at most 1200 g/m², preferably of at most 500 g/m², more preferably of at most 250 g/m², even more preferably of at most 125 g/m², even more preferably of at most 60 g/m², and most preferably of at most 40 g/m².

In another preferred embodiment, the first cover layer and/or the second cover layer provide an acoustic effect.

In a preferred embodiment, the textile fabric of the first cover layer comprises fibers and is preferably a woven, a knitted fabric, a spun-laid nonwoven, a carded nonwoven, an air-laid nonwoven, a wet-laid nonwoven, a meltblown nonwoven, a layer of unidirectional fibers, a net, a scrim, a two-dimensional entangled mat of extruded filaments, or any combination thereof.

In another preferred embodiment, the textile fabric of the second cover layer comprises fibers and is preferably a woven, a knitted fabric, a spun-laid nonwoven, a carded nonwoven, an air-laid nonwoven, a wet-laid nonwoven, a meltblown nonwoven, a layer of unidirectional fibers, a net, a scrim, a two-dimensional entangled mat of extruded filaments, or any combination thereof.

Preferably, the textile fabric of the first cover layer and the second cover layer comprise fibers and are preferably a woven, a knitted fabric, a spun-laid nonwoven, a carded nonwoven, an air-laid nonwoven, a wet-laid nonwoven, a meltblown nonwoven, a layer of unidirectional fibers, a net, a scrim, a two-dimensional entangled mat of extruded filaments, or any combination thereof.

In another preferred embodiment, the fibers of the textile fabric of the first cover layer and/or the second cover layer comprise one or more synthetic polymeric material(s), preferably one or more thermoplastic polymeric material(s).

Preferably, the synthetic polymeric material of the fibers of the textile fabric is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

In another preferred embodiment, the fibers of the textile fabric are monofilaments, multifilament yarns, mono-component fibers, two types of mono-component fibers, bicomponent fibers, and/or multicomponent fibers.

Preferably, the bicomponent fibers are of an eccentric core/sheath model, a concentric core/sheath model, a side by side model, an island-in-the-sea model, a segmented-pie model or a split segmented-pie model.

Also preferably, the multicomponent fibers are of a side by side model, an island-in-the-sea model, a segmented-pie model or a split segmented-pie model.

Within the scope of the invention, the “split segmented pie model” has to be understood as fibers originating from a bicomponent or multicomponent fiber of the segmented-pie model, which are obtained by splitting or separating the individual segments of the segmented-pie from each other by any suitable method, for example by hydroentanglement, by applying a stress and/or a heat treatment. The thus obtained fibers are smaller than the original segmented-pie fiber.

Without being bound to theory, it is believed that by using such fibers of the split segmented-pie model, the textile fabric comprising such fibers have improved acoustic properties.

In a further preferred embodiment, the two types of mono-component fibers are made of the same synthetic polymeric material, of two synthetic polymeric materials of the same polymer family or of two different synthetic polymeric materials. Preferably, the two types of mono-component fibers are made of two synthetic polymeric materials of the same polymer family or of two different synthetic polymeric materials.

Within the scope of the invention, two types of fibers may also be different in length, titer, and/or cross section area of the fibers and not only in view of the synthetic polymeric material.

Within the scope of the invention, it has to be understood that the term “polymer family” means polymers comprising at least 50% of the same chemical bonds between the monomeric units of the synthetic polymeric materials. Further, the expression “different synthetic polymeric materials” has to be understood that at least 50% of the chemical bond between the monomeric units of the synthetic polymeric materials are different.

In a preferred embodiment of the invention, the fibers of the textile fabric have an average diameter of at most 100 μm, preferably of at most 80 μm, more preferably of at most 50 μm, even more preferably of at most 30 μm, and most preferably of at most 20 μm.

In another preferred embodiment, the fibers of the textile fabric are filaments or staple fibers. Preferably, the fibers of the textile fabric are filaments.

Without being bound to theory, it is believed that a textile fabric comprising to filaments has a higher degree of stability, as forces applied onto the textile fabric in plane of the x- and y-direction are distributed along the length filaments.

Preferably, the two-dimensional entangled mat of extruded filaments is provided by extruding polymeric filaments and collecting the extruded filaments onto an even surface to provide a two-dimensional structure by allowing the filaments to bend, to entangle and to come into contact with each other, preferably in a still molten state.

Without being bound to theory, as the filaments of two-dimensional entangled mat of extruded filaments are extruded and entangled, the filaments have friction points and/or bonding points. This does not improved solely the stability in the plane of the x-direction and y-direction, it also increases the stability in z-direction as a force applied in z-direction is dispersed in x-direction and/or y-direction due to the frictions points and/or bonding points.

In a preferred embodiment of the invention, the filaments of the two-dimensional entangled mat of extruded filaments comprise a synthetic polymeric material, more preferably the filaments comprise a thermoplastic polymeric material.

In a preferred embodiment, the synthetic polymeric material of the filaments of the two-dimensional entangled mat of extruded filaments is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

Without being bound to theory, it is believed that a two-dimensional entangled mat of extruded filaments comprising filaments made of thermoplastic polyurethane (TPU) have anti-skid properties. This could be helpful for the composite used in an floor underlayment such that skidding of the composite can be prevented or at least reduced.

The filaments of the two-dimensional entangled mat of extruded filaments can have any suitable average filament diameter, preferably the filaments of the two-dimensional entangled mat of extruded filaments have an average diameter of at least 100 μm, preferably an average diameter between 100 μm and 2000 μm, more preferably between 200 μm and 1500 μm, even more preferably between 300 μm and 1000 μm, even more preferably between 400 μm and 800 μm, and most preferably between 500 μm and 700 μm.

In a preferred embodiment, the first cover layer is a first laminate comprising a first nonwoven, a film, and a second nonwoven.

In another preferred embodiment, the second cover layer is a second laminate comprising a first nonwoven, a film, and a second nonwoven.

Preferably, the first cover layer is a first laminate and the second cover layer is a second laminate, wherein each laminate comprises a first nonwoven, a film, and a second nonwoven.

Preferably, the first nonwoven of the first laminate is a carded nonwoven, a mechanically consolidated nonwoven, and/or a thermally consolidated nonwoven, the film of the first laminate is a water impermeable film, and the second nonwoven of the first laminate is preferably a spunbonded nonwoven.

Preferably, the first nonwoven of the second laminate is a carded nonwoven, a mechanically consolidated nonwoven, and/or a thermally consolidated nonwoven, the film of the second laminate is a water impermeable film, and the second nonwoven of the second laminate is preferably a spunbonded nonwoven.

Even more preferably, the first nonwoven of the first laminate comprises polyethylene terephthalate and the second nonwoven of the first laminate comprises polypropylene.

Even more preferably, the first nonwoven of the second laminate comprises polyethylene terephthalate and the second nonwoven of the second laminate comprises polypropylene.

In a preferred embodiment, the film of the first laminate is a continuous layer, a discontinuous layer, a film, a slit film, an adhesive, a hotmelt, a woven fabric, a nonwoven fabric, and/or a foam.

Preferably, the textile fabric of the film of the first laminate comprises fibers and is preferably a woven, a knitted fabric, a spun-laid nonwoven, a carded nonwoven, an air-laid nonwoven, a wet-laid nonwoven, a meltblown nonwoven, a layer of unidirectional fibers, a net, a scrim, a two-dimensional entangled mat of extruded filaments, or any combination thereof.

In a further preferred embodiment, the film of the second laminate is a continuous layer, a discontinuous layer, a film, a slit film, an adhesive, a hotmelt, a woven fabric, a nonwoven fabric, and/or a foam.

In a preferred embodiment, the textile fabric of the second cover layer comprises fibers and is preferably a woven, a knitted fabric, a spun-laid nonwoven, a carded nonwoven, an air-laid nonwoven, a wet-laid nonwoven, a meltblown nonwoven, a layer of unidirectional fibers, a net, a scrim, a two-dimensional entangled mat of extruded filaments, or any combination thereof.

Without being bound to theory, it is believed that the first laminate and/or the second laminate increase the mechanical stability of the composite by the nonwovens and also increase the acoustic properties by the film, the first nonwoven and the second nonwoven.

Within the scope of the invention, by using the term “mechanically consolidated” means that the nonwoven is consolidated by any mechanical method e.g. hydroentanglement or mechanical needling.

In a preferred embodiment of the invention, the first cover layer comprises a synthetic polymeric fiber material, a natural polymeric fiber material, a mineral polymeric fiber material, or a combination thereof.

In another preferred embodiment of the invention, the second cover layer comprises a synthetic polymeric fiber material, a natural polymeric fiber material, a mineral polymeric fiber material, or a combination thereof.

Preferably, the first cover layer and the second cover layer comprises a synthetic polymeric fiber material, a natural polymeric fiber material, a mineral polymeric fiber material, or a combination thereof.

The advantage of a synthetic polymeric material is typically that the material is cheap, can be manufactured is huge amounts and has a constant quality and has advantageous physical properties such as elongation, elasticity and toughness. An advantage of natural polymeric material is that the material is renewable such that there is less environmental pollution by using such a material. An advantage of a mineral polymeric material is typically that the material has advantageous physical properties such as tensile strength, modulus, inflammableness and fire retardancy.

In a preferred embodiment, the first cover layer comprises a synthetic polymeric material, preferably a thermoplastic polymeric material.

In another preferred embodiment, the second cover layer comprises a synthetic polymeric material, preferably a thermoplastic polymeric material.

Preferably, the first cover layer and the second cover layer comprise a synthetic polymeric material, preferably a thermoplastic polymeric material.

In a preferred embodiment, the first cover layer comprises a synthetic polymeric fiber material, preferably a thermoplastic polymeric fiber material.

In another preferred embodiment, the second cover layer comprises a synthetic polymeric fiber material, preferably a thermoplastic polymeric fiber material.

Preferably, the first cover layer and the second cover layer comprise a synthetic polymeric fiber material, preferably a thermoplastic polymeric fiber material.

In a further preferred embodiment, the first intermediate layer, the second intermediate layer, the first cover layer and the second cover layer comprise one or more synthetic polymeric material(s).

Without being bound to theory, it is believed that in the case the first intermediate layer, the second intermediate layer, the first cover layer and the second cover layer comprises synthetic polymeric materials, it is easier to bond the layer together e.g. by thermo bonding. Further, it is believed that the adhesion between these layers is increased.

In another preferred embodiment, the first intermediate layer, the second intermediate layer, the first cover layer and the second cover layer comprise solely one synthetic polymeric material, comprise two or more synthetic polymeric materials of the same polymer family, comprise two or more different synthetic polymeric materials or a combination of two or more synthetic polymeric material of the same polymer family or two or more different synthetic polymeric materials.

Without being bound to theory, it is believed that in the case the first intermediate layer, the second intermediate layer, the first cover layer and the second cover layer comprise two or more synthetic polymeric materials of the same polymer family, comprise two or more different synthetic polymeric materials or a combination of two or more synthetic polymeric material of the same polymer family or two or more different synthetic polymeric materials, the requirements for a composite can be better targeted as the synthetic polymer material can be selected as required.

Preferably, the first intermediate layer, the second intermediate layer, the first cover layer and the second cover layer comprise two or more synthetic polymeric materials of the same polymer family, comprise two or more different synthetic to polymeric materials or a combination of two or more synthetic polymeric material of the same polymer family and two or more different synthetic polymeric materials.

Without being bound to theory, it is believed that in the case the first intermediate layer, the second intermediate layer, the first cover layer and the second cover layer comprise solely one synthetic polymeric material or synthetic polymeric materials of the same polymer family, it is easier to recycle the composite as the layers do not need to be separated before they are recycled.

In a preferred embodiment, the synthetic polymeric material of the first cover layer has a melting temperature T_{m,CL1}, the synthetic polymeric material of the second cover layer has a melting temperature T_{m,CL2}, and the synthetic polymeric material of the first intermediate layer has a melting temperature T_{m,IL1} and the second intermediate layer has a melting temperature T_{m,IL2}, wherein the melting temperature T_{m,IL1} is smaller than T_{m,CL1} and the melting temperature T_{m,IL2} is smaller than the melting temperature T_{m,CL2}, preferably the melting temperatures of T_{m,IL1} and T_{m,IL2} are smaller than T_{m,CL1} and T_{m,CL2}.

Without being bound to theory, it is believed that if the melting temperature of the first intermediate layer is smaller than the melting temperatures of the first cover layer and the melting temperature of the second intermediate layer is smaller than the melting temperature of the second cover layer, the layers can be thermally bonded together, wherein the stability of the first cover layer and the second cover layer is maintained. This concept is also true for the case that the melting temperatures of the first intermediate layer T_{m,IL1} and the second intermediate layer T_{m,IL2} are smaller than the melting temperatures of the first cover layer T_{m,CL1} and the second cover layer T_{m,CL2}.

In a preferred embodiment, the synthetic polymeric material of the fibers of the first cover layer is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

In a further preferred embodiment, the synthetic polymeric material of the fibers of the second cover layer is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

Preferably, the synthetic polymeric material of the fibers of the first cover layer and the second cover layer is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

The thickness of the uncut flat body, which is to be plastically deformed and folded into a core having a three-dimensional structure, may be varied widely. Preferably, the thickness of the uncut flat body will be in the range of 0.05 mm to 2.0 mm.

When the thickness of the uncut flat body is selected to be less than 0.05 mm, the risk of tearing the uncut flat body during plastically forming consecutive 3D-structures increases. When the thickness of the uncut flat body is selected to be more than 2.0 mm, plastically forming consecutive 3D-structures in the uncut flat body becomes more difficult due to increased stiffness of the uncut flat body and/or the uniform heating of the uncut flat body becomes more difficult. More preferably, the thickness of the uncut flat body will be in the range of 0.1 mm to 0.5 mm. Most preferably the thickness of the uncut flat body is 0.15 mm to 0.3 mm for an optimum balance between formability of 3D structures without tearing the uncut to flat body.

In a preferred embodiment, the core has a three-dimensional form comprising a honeycomb structure, a relaxed honeycomb structure, a trapezoidal structure or a structure comprising cylindrical and/or truncated cone like projections.

A preferred honeycomb structure and a preferred relaxed honeycomb structure provided from an uncut flat body have been described above and also in by WO 2006/053407 A1. Another way to provide a core having a three-dimensional form from an uncut flat body is deep drawing or thermo drawing of a drawable uncut flat body. Preferably, a structure comprising cylindrical and/or truncated cone like projections is provided by deep drawing or thermo drawing.

Without being bound to theory, it is believed that due to the three-dimensional structure and the comprised void volumes, the reduction of noise is increased. Also, due to the form of the core the stability, e.g. the compression resistance of the composite, is increased.

As disclosed by WO 2006/053407 the half closed honeycomb structure can have closed connecting areas. Preferably, the connecting areas of the half closed honeycomb structure can be open or comprise a hole. The hole can have any geometry, even a random geometry. Further, the relaxed honeycomb structure comprises connecting areas which can be closed. Preferably, the connecting areas of the relaxed honeycomb structure are open or comprise holes. The hole can have any geometry, even a random geometry.

In a further preferred embodiment, the core comprises a synthetic polymeric material. Preferably, the synthetic polymeric material of the core is selected from a group consisting of polycarbonates, polyesters such as polyethylene terephthalate (PET), polytrimethylene terephthalate (PTT), polybutylene terephthalate (PBT), polyethylene naphthalate (PEN), polyethylene-1,2-furandicaboxylate (PEF), polyolefins such as polyethylene (PE), polypropylene (PP), polyamides such as polyamide-6 (PA6), polyamide 6,6 (PA66), thermoplastic polyurethane (TPU), and blends or co-polymers thereof.

In a preferred embodiment, the honeycomb cells comprised in the honeycomb structure have a diameter of 1 mm to 60 mm, preferably of 2 to 40 mm, and more preferably of 2 to 30 mm, even more preferably of 2 to 20 mm, and most preferably of 3 to 10 mm.

The diameter of the honeycomb cells comprised in the honeycomb structure is measured as the perpendicular distance between two walls, oriented parallel to each other, of two consecutive half hexagonal cells of the honeycomb structure in machine direction.

In another preferred embodiment, the honeycomb cells comprised in the honeycomb structure have a height of 1 mm to 60 mm, preferably of 2 mm to 30 mm, and more preferably of 3 to 20 mm, and most preferably of 3 to 10 mm.

The honeycomb cells of the honeycomb structure according to WO 2006/053407 A1 are half closed such that only on one side of the honeycomb a connecting area is present. Accordingly, the height is measured as the perpendicular distance between the connecting area and the end of the walls of the honeycomb cells comprised in the honeycomb structure.

In a preferred embodiment, the relaxed honeycomb structure comprises half hexagonal cells, wherein two in machine direction consecutive half hexagonal cells form an angle of at most 110°, preferably of at most 90°, more preferably of at most 80° even more preferably of at most 75°, and most preferably of at most 70°.

In another preferred embodiment, the relaxed honeycomb structure comprises half hexagonal cells, wherein two in machine direction consecutive half hexagonal cells form an angle of at least 1°, preferably of at least 15°, more preferably of at least 30°, and most preferably of at least 35°.

Preferably, the relaxed honeycomb structure comprises half hexagonal cells, wherein two in machine direction consecutive half hexagonal cells form an angle of up to 110°, preferably between 1° and 90°, more preferably between 15° and 80° even more preferably between 30° and 75°, and most preferably between 35° and 70°.

Without being bound to theory, it is believed that an angle exceeding 110° will decrease the stability, e.g. the compression resistance, of the composite, in particular of the relaxed honeycomb structure.

In a preferred embodiment, the relaxed honeycomb structure comprises half hexagonal cells having a diameter d_{half} of 0.5 mm to 30 mm, preferably of 1 to 20 mm, and more preferably of 1 to 15 mm, even more preferably of 1 to 10 mm, and most preferably of 1.5 to 5 mm.

In contrast to the honeycomb structure, the relaxed honeycomb structure is not fully folded, such that the connecting area of a honeycomb cell comprises a kink. Thus, the diameter of the half hexagonal cells d_{half} of the relaxed honeycomb structure is determined by measuring the distance between the kink and the cell wall of the half hexagonal cell walls of the relaxed honeycomb structure in the plane of the connecting area, which is oriented parallel to the kink, wherein the distance is measured perpendicular to the kink and perpendicular to the parallel oriented honeycomb cell wall. To provide the diameter of the honeycomb cells of the relaxed honeycomb structure, the diameters d_{half} of both half hexagonal cells, which share the same connecting area having a kink, have to be summed up.

Preferably, the honeycomb cells comprised in the relaxed honeycomb structure have a diameter of 1 mm to 60 mm, preferably of 2 to 40 mm, and more preferably of 2 to 30 mm, even more preferably of 2 to 20 mm, and most preferably of 3 to 10 mm.

In another preferred embodiment, the half hexagonal cells of the relaxed honeycomb structure have a height of 1 mm to 60 mm, preferably of 2 mm to 20 mm, and more preferably of 3 to 15 mm, and most preferably of 3 to 10 mm.

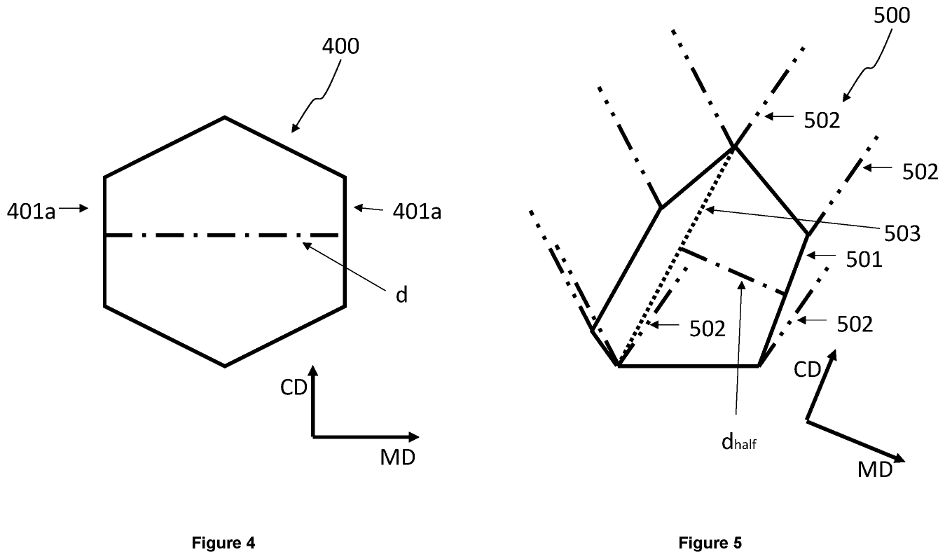

The method of determining the height of the half hexagonal cells of the honeycomb structure is also applicable to the half hexagonal cells of the relaxed honeycomb structure. The distance, i.e. the diameter and the height of the honeycomb cells are indicated by dashed lines in FIGS. 4-7.

Preferably, the honeycomb cells comprised in the honeycomb structure or the relaxed honeycomb structure have a diameter of 1 mm to 60 mm, preferably of 2 to 40 mm, and more preferably of 2 to 30 mm, even more preferably of 2 to 20 mm, and most preferably of 3 to 10 mm and/or the honeycomb cells have a height of 1 mm to 60 mm, preferably of 2 mm to 30 mm, and more preferably of 3 to 20 mm, and most preferably of 3 to 10 mm.

The composite according to the embodiments disclosed herein above can also be advantageously used to reduce noise in buildings, such as multistoried apartments and houses. The composite according to the embodiments disclosed herein above can in particular be used in a flooring system, in a wall system or in a ceiling system.

The object is also solved by a flooring system comprising a floor covering and an underlayment, the underlayment comprising the composite according to the embodiments disclosed herein above.

The floor covering comprised in the flooring system may be varied, and may be selected from the group consisting of laminate, parquet, vinyl flooring, in particular polyvinylchloride (PVC) flooring, a floating screed, a tufted floor covering, in particular a tufted carpet, the tufted carpet preferably comprising a primary backing and tufting yarns tufted into the primary carpet backing.

The flooring system may comprise a floor covering, an underlayment and a subfloor or surface, wherein the underlayment is applied onto the subfloor or surface. The subfloor or surface may be varied, and may be selected from concrete or wooden floor slabs, ceramic tiles, poured top floors or tufted floor coverings.

The underlayment may be applied directly on previously installed floor coverings, such as for example ceramic tiles or tufted floor coverings as the underlayment enables to accommodate for any unevenness in the subfloor or surface.

The object is also solved by a wall system comprising a wall surface covering and the composite according to the embodiments disclosed herein above. The wall system may be a structural wall of the building or may be a portable wall, such as for example a panel used as a room divider.

The object is also solved by a ceiling system comprising a ceiling surface covering and the composite according to the embodiments disclosed herein above.

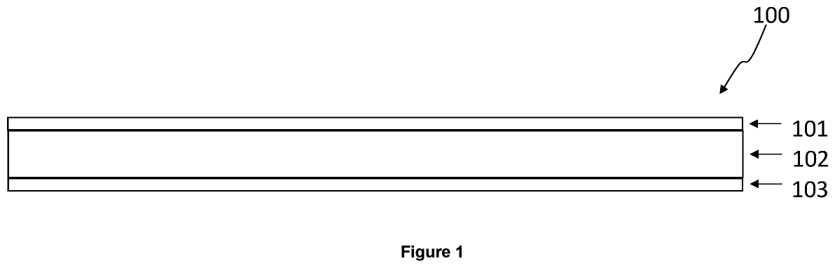

FIG. 1: Schematic cross sectional view of a composite according to the invention.

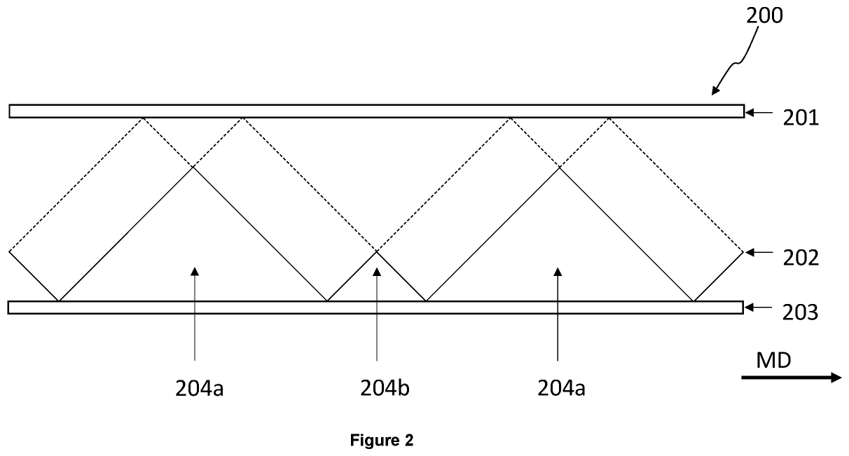

FIG. 2: Schematic cross sectional view of a composite according to a preferred embodiment of the invention.

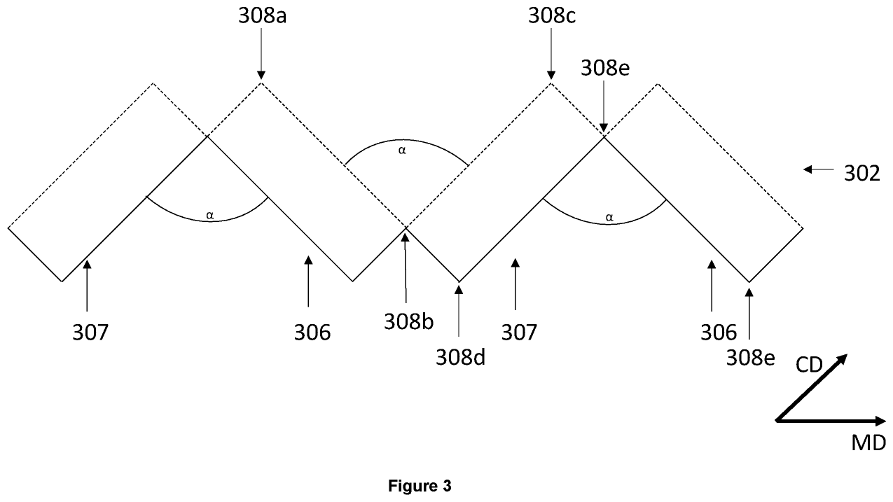

FIG. 3: Schematic cross sectional view of a relaxed honeycomb structure.

FIG. 4: Schematic top view of a honeycomb cell.

FIG. 5: Schematic perspective view of a part of a honeycomb cell of a relaxed honeycomb structure.

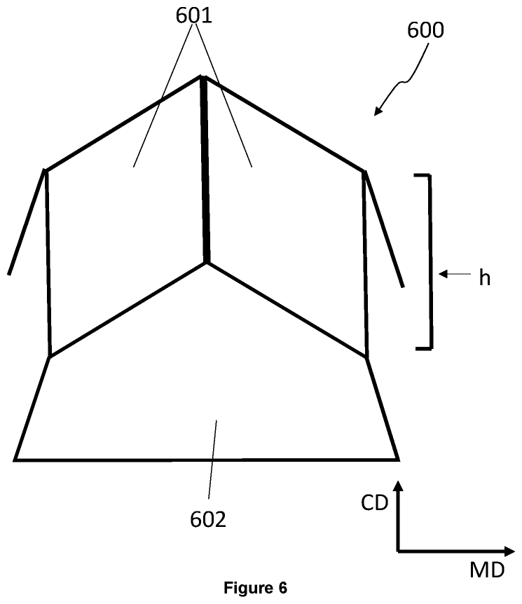

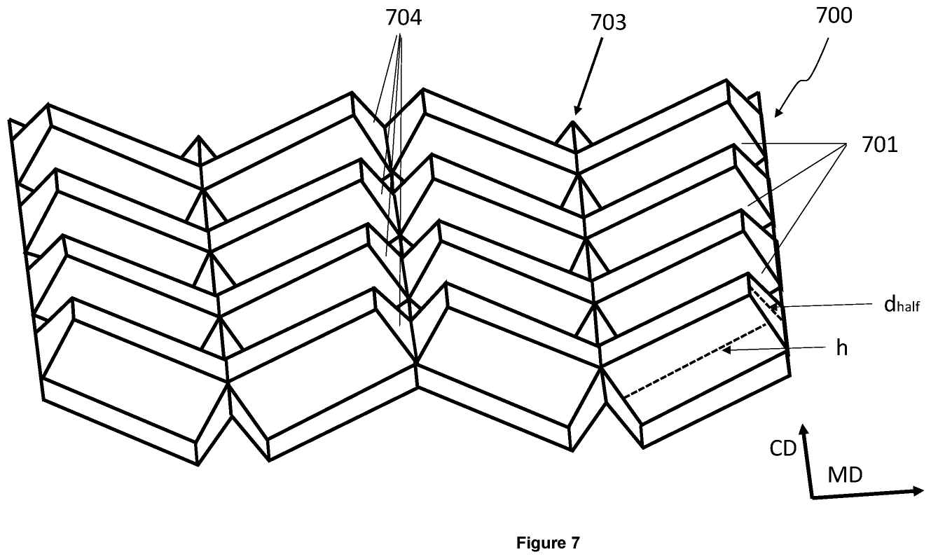

FIG. 6 Schematic cross sectional view of a fully folded honeycomb cell of a honeycomb structure.

FIG. 7: Schematic perspective view of a part of a relaxed honeycomb structure

FIG. 1 shows a schematic cross sectional view of a composite according to the invention comprising a core 102 provided from an uncut flat body, a first cover layer 101, which is in contact with the first main surface (not shown) of the core 102 and a second cover layer 103, which is contact with the second main surface (not shown) of the core 102.

FIG. 2 shows a schematic cross sectional view of a composite comprising a relaxed honeycomb structure 202 as a core, a first cover layer 201, which is in contact with the first main surface (not shown) of the relaxed honeycomb structure 202, and a second cover layer 203, which is in contact with the second main surface (not shown) of the relaxed honeycomb structure 202. Further, the composite 200 comprises void volumes 204a/b between the cover layers 201 and 203 and the relaxed honeycomb structure 202. The machine direction MD is indicated by an arrow.

FIG. 3 shows a side view of a relaxed honeycomb structure 302, which has an angle α between two in machine direction consecutive half honeycomb cells 306 and 307. Thereby, the two half honeycomb cells are folded such that an angle α is established by the corner points 308a-c and 308d-f. The machine direction MD and cross direction CD are indicated by arrows.

FIG. 4 shows a schematic top view of a honeycomb cell 400. In this honeycomb cell 400 the diameter d is the perpendicular distance between two parts 401a of two consecutive half hexagonal cell walls of the honeycomb structure in machine direction, which are oriented parallel to each other. The machine direction MD and cross direction CD are indicated by arrows.

FIG. 5 shows a schematic perspective view of a part of a honeycomb cell of a relaxed honeycomb structure 500 comprising a kink 503 and a cell wall of the half hexagonal cell walls of the relaxed honeycomb structure 501, which is oriented parallel to the kink 503. The diameter of the honeycomb cells of the relaxed honeycomb structure is determined by measuring the diameter d_{half} between the kink 503 and the cell wall of the half hexagonal cell of the relaxed honeycomb structure 501, which is perpendicular to the kink 503 and perpendicular to the plane of the cell wall 501, and sum up the diameters d_{half} of two half hexagonal cells, which share the same kink 503. The partially dashed lines 502 indicates the half hexagonal cell of the relaxed honeycomb structure. The machine direction MD and cross direction CD are indicated by arrows.

FIG. 6 shows a schematic cross sectional view of a fully folded honeycomb cell of a honeycomb structure 600 comprising a connecting area 602 and honeycomb cell walls 601. The height of the fully folded honeycomb cell 600 is measured as the perpendicular distance between the plane of connecting area 604 and the end of the honeycomb walls 601. The machine direction MD and cross direction CD are indicated by arrows.

FIG. 7 shows a part of a relaxed honeycomb structure 700 half hexagonal honeycomb cells 701 having a height h and a half diameter d_{half}. Also the relaxed honeycomb structure 700 comprises kinks 703 and connecting areas 704. The machine direction MD and cross direction CD are indicated by arrows.

1. A composite comprising:
a core, a first cover layer (101) and a second cover layer,
wherein the core is provided from an uncut flat body,
wherein the core is a three dimensional structure having a first main surface and a second main surface, the first cover layer is in contact with the first main surface creating multiple contact areas and the second cover layer is in contact with the second main surface creating multiple contact areas,
wherein the multiple contact areas between the first cover layer and the first main surface are offset in x-direction and y-direction to the multiple contact areas between the second cover layer and the second main surface,
wherein the first cover layer and the second cover layer are different.

2. The composite according to claim 1, wherein a first intermediate layer is located between the first cover layer and the first main surface and/or a second intermediate layer is located between the second cover layer and the second main surface.

3. The composite according to claim 2, wherein the first intermediate layer and/or the second intermediate layer is a continuous layer, a discontinuous layer, a film, a slit film, an adhesive, a hotmelt, a woven fabric, a nonwoven fabric, a continuous fiber web, a discontinuous fiber web, and/or a foam.

4. The composite according to claim 2, wherein the first intermediate layer and/or the second intermediate layer has a weight of at most 1200 g/m², preferably of at most 300 g/m², even more preferably of at most 200 g/m² even more preferably of at most 150 g/m², even more preferably of at most 100 g/m², and most preferably of at most 50 g/m².

5. The composite according to claim 1, wherein the first cover layer and/or the second cover layer is a foam, a textile fabric, a sheet of material, a laminate of two or more layers, or any combination thereof.

6. The composite according to claim 1, wherein the first cover layer and/or the second cover layer has a weight of at most 1200 g/m², preferably of at most 500 g/m², more preferably of at most 250 g/m², even more preferably of at most 125 g/m², even more preferably of at most 60 g/m², and most preferably of at most 40 g/m².

7. The composite according to claim 5, wherein the textile fabric comprises fibers and is preferably a woven, a knitted fabric, a spun-laid nonwoven, a carded nonwoven, an air-laid nonwoven, a wet-laid nonwoven, a meltblown nonwoven, a layer of unidirectional fibers, a net, a scrim, a two-dimensional entangled mat of extruded filaments, or any combination thereof.

8. The composite according to claim 7, wherein the fibers of the textile fabric are monofilaments, multifilament yarns, mono-component fibers, two mono-component fibers and/or bicomponent fibers.

9. The composite according to claim 1, wherein the uncut flat body is plastically deformed.

10. The composite according to claim 9, wherein the core is obtained from the plastically deformed uncut flat body by folding.

11. The composite according to claim 1, wherein the core has a three-dimensional form comprising a honeycomb structure, a trapezoidal structure or a structure comprising cylindrical and/or truncated cone like projections.

12. The composite according to claim 10, wherein the cells comprised in the honeycomb structure have a diameter of 1 mm to 60 mm, preferably of 2 to 40 mm, and more preferably of 2 to 30 mm, even more preferably of 2 to 20 mm, and most preferably of 3 to 10 mm and/or honeycomb cells have a height of 1 mm to 60 mm, preferably of 2 mm to 30 mm, and more preferably of 3 to 20 mm, and most preferably of 3 to 10 mm.

13. The composite according to claim 10, wherein the core comprises half-hexagonal cell walls, is folded such that the cell walls are not fully vertical and is preferably rollable.

14. The composite according to claim 13, wherein two in machine direction consecutive half hexagonal cells form an angle of up to 110°, preferably between 1° and 90°, more preferably between 15° and 80°, even more preferably between 30° and 75°, and most preferably between 35° and 70°.

15. The composite according to claim 13, wherein the half-hexagonal cells comprised in the core structure have a diameter of 1 mm to 60 mm, preferably of 2 to 40 mm, and more preferably of 2 to 30 mm, even more preferably of 2 to 20 mm, and most preferably of 3 to 10 mm and/or the half-hexagonal cells have a height of 1 mm to 60 mm, preferably of 2 mm to 30 mm, and more preferably of 3 to 20 mm, and most preferably of 3 to 10 mm.
